(19) United States
(12) Patent Application Publication
(10) Pub. No.: US 2004/0131846 A1
(43) Pub. Date: Jul. 8, 2004

(54) Microsphere containing electron beam cured pressure-sensitive adhesive tapes and methods of making and using same

(76) Inventors: Thomas C. Epple, Madison, OH (US); Donald L. Chapman, Concord, OH (US)

Correspondence Address: Heidi A Boehlefeld, Renner Otto Boisselle and Sklar LLP, 1621 Euclid Avenue Nineteenth Floor, Cleveland, OH, 44115-2191, US

(21) Appl. No.: 10/732,306

(22) Filed: Dec. 11, 2003

Related U.S. Application Data
(60) Provisional application No. 60/434,919, filed on Dec. 19, 2002.

(51) Int. Cl. B32B 7/12

(52) U.S. Cl. 428/345; 428/354; 428/343

(57) ABSTRACT

The present invention provides pressure sensitive adhesive tape including at least one electron beam cured (EB-cured), rubber-based pressure sensitive adhesive (PSA) core including microspheres. The core layer is coated on at least one side, and in one embodiment, on both sides, with a skin layer including an EB-cured rubber-based PSA that is substantially free of microspheres. The core layer may comprise a lamination seam, a second core layer or a non-woven support layer.

This application claims the benefit of Provisional Application 60/434,919 filed Dec. 19, 2002.

### TECHNICAL FIELD OF THE INVENTION

This invention relates to microsphere containing pressure-sensitive adhesive tapes, and more particularly to microsphere containing electron beam cured rubber-based pressure-sensitive adhesive tapes, and to methods of making and using the same.

### BACKGROUND OF THE INVENTION

A variety of double-sided foam pressure-sensitive adhesive (PSA) tapes have been used for structural bonding in various applications, replacing spot welds, tack welds, rivets and other mountings of objects on substrates. Such applications include, for example, the bonding of body-side molding to automobiles and other vehicles, fiberglass body panels to motor homes, Plexiglas inspection windows onto equipment cabinets, and the like. The foam layer of these PSA tapes usually has a polymer matrix based on polyethylene, polyurethane, polyvinyl chloride, or polychloroprene. Many of these tapes exhibit poor conformability around curved substrates, and/or exhibit poor adhesion to surfaces such as painted or thermoplastic polyolefin (TPO) surfaces. In some cases it has been necessary to apply a primer to the surface prior to placement of the object, in order to obtain adequate adhesion. In such uses, the adhesive tapes generally are not intended to be detachable. However, particularly in applications such as automotive or other outdoor uses, the adhesive tape may be exposed to sunlight, water, organic materials such as gasoline, and solvents such as alcohols used in windshield washer fluid or antifreeze. These elements undesirably can result in detachment of the object mounted on the substrate or surface.

Accordingly, a need exists for a foamed PSA tape for use in such applications which provides a strong, permanent, yet conformable attachment of an object to a desired substrate, that can withstand the various forces and elements to which it will be exposed during its useful life.

### SUMMARY OF THE INVENTION

The present invention provides pressure sensitive adhesive tape including at least one electron beam cured (EB-cured), rubber-based pressure sensitive adhesive (PSA) core including microspheres. The core layer is coated on at least one side, and in one embodiment, on both sides, with a skin layer including an EB-cured rubber-based PSA that is substantially free of microspheres. The core layer may comprise a lamination seam, a second core layer or a non-woven support layer. The present invention also relates to a method of mounting an object on a substrate by means of a PSA tape including at least one EB-cured, rubber-based PSA core including microspheres. The core layer is coated on at least one side, and in one embodiment, on both sides, with a skin layer including an EB-cured rubber-based PSA that is substantially free of microspheres.

The pressure-sensitive adhesive tapes of the present invention exhibit high conformability that arises from the low elastic memory of the core layer. The tapes also exhibit high failure strain, high cleavage peels and tensile adhesion, and good gasoline and moisture resistance.

In one embodiment, the present invention relates to a pressure-sensitive adhesive (PSA) tape, including an electron beam-cured (EB-cured) rubber-based PSA core comprising non-rigid polymeric microspheres and having first and second major faces; and an EB-cured rubber-based PSA skin layer adhered to the first major face, in which the EB-cured rubber-based PSA skin layer is substantially free of microspheres. In one embodiment, the tape further includes a second EB-cured rubber-based PSA skin layer having a first major face and a second major face, in which the first major face of the second EB-cured rubber-based PSA skin layer is adhered to the second major face of the EB-cured rubber-based PSA core. In another embodiment, the tape further includes a second EB-cured rubber-based PSA core including non-rigid polymeric microspheres adhered to the second major face of the second EB-cured rubber-based PSA skin layer, and may even further include a third EB-cured rubber-based PSA skin layer adhered to the second core. In another embodiment, the present invention relates to a PSA tape further including a non-woven polymeric support layer between the first major face of the second EB-cured rubber-based PSA skin layer and the second major face of the EB-cured foamed rubber-based PSA core.

In yet another embodiment, the present invention further relates to a PSA tape including a EB-cured rubber-based PSA core including microspheres and having first and second major faces; and an EB-cured rubber-based PSA skin layer adhered to the first major face, in which the EB-cured rubber-based PSA skin layer is substantially free of microspheres, a second EB-cured rubber-based PSA core including microspheres and having first and second major faces; a second EB-cured rubber-based PSA skin layer adhered to the first major face of the second EB-cured rubber-based PSA core, in which the second EB-cured rubber-based PSA skin layer is substantially free of microspheres and the second major face of the first core is adhered to the second major face of the second core, forming a lamination seam.

In another embodiment, the present invention relates to a double-sided adhesive tape, including a first EB-curable rubber-based PSA core including microspheres and having first and second major faces; a first EB-curable rubber-based PSA skin layer adhered to the first major face of the first EB-curable rubber-based PSA core; a second EB-curable rubber-based PSA core comprising microspheres and having first and second major faces, in which the first major face of the second EB-curable rubber-based PSA core is adhered to the second major face of the first EB-curable rubber-based PSA core, in which a lamination seam is formed between the first EB-curable rubber-based PSA core and the second EB-curable rubber-based PSA core; a second EB-curable rubber-based PSA skin layer adhered to the first major face of the second EB-curable rubber-based PSA core, in which both the first and the second EB-curable rubber-based PSA skin layers are substantially free of microspheres.

In another embodiment, the present invention relates to a double-sided adhesive tape, including a first EB-curable rubber-based PSA core including microspheres and having first and second major faces; an EB-curable rubber-based PSA skin layer adhered to the first major face of the first EB-curable rubber-based PSA core, in which the EB-curable rubber-based PSA skin layer is substantially free of microspheres; a second EB-curable rubber-based PSA core including microspheres and having first and second major faces, in which the first major face of the second EB-curable rubber-based PSA core is adhered to the second major face of the first EB-curable rubber-based PSA core, and a lamination seam is formed between the first EB-curable rubber-based PSA core and the second EB-curable rubber-based PSA core.

In yet another embodiment, the present invention relates to methods of making and using the adhesive tapes. For example, in one embodiment, the present invention relates to a method of mounting an object on a substrate, including providing an object and a substrate to which the object is to be adhered; providing an EB-curable rubber-based PSA tape; adhering the object to one side of the PSA tape; and adhering the other side of the PSA tape to the substrate. Additional core or skin layers may be added to the PSA tape, as needed for various applications.

### BRIEF DESCRIPTION OF THE DRAWINGS

FIG. 1 is a schematic cross-sectional view of an adhesive tape having a core and one skin layer in accordance with one embodiment of the present invention.

FIG. 2 is a schematic cross-sectional view of an adhesive tape having a core and two skin layers in accordance with another embodiment of the present invention.

FIG. 3 is a schematic cross-sectional view of an adhesive tape having two core layers with one skin layer on one of the core layers and a non-woven polymer support layer separating the core layers in accordance with yet another embodiment of the present invention.

FIG. 4 is a schematic cross-sectional view of an adhesive tape having two core layers with one skin layer on one of the core layers and a separator layer that is substantially free of microspheres in accordance with still another embodiment of the present invention.

FIG. 5 is a schematic cross-sectional view of an adhesive tape having two core layers with a skin layer on each of the core layers and a separator layer that is substantially free of microspheres in accordance with yet another embodiment of the present invention.

FIG. 6 is a schematic cross-sectional view of an adhesive tape having two core layers, two skin layers and a lamination seam between the core layers in accordance with still another embodiment of the present invention.

FIG. 7 is a schematic cross-sectional view of an adhesive tape having two core layers, two skin layers and a non-woven polymeric support layer between the core layers in accordance with another embodiment of the present invention.

FIG. 8 is a schematic cross-sectional view of an adhesive tape having two core layers, one skin layer and a lamination seam between the core layers in accordance with an embodiment of the present invention.

It should be appreciated that for simplicity and clarity of illustration, elements shown in the Figures have not necessarily been drawn to scale. For example, the dimensions of some of the elements are exaggerated relative to each other for clarity. Further, where considered appropriate, reference numerals have been repeated among the Figures to indicate corresponding elements.

Furthermore, it should be appreciated that the process steps and structures described below may not form a complete process flow for manufacturing the final PSA tapes. The present invention can be practiced in conjunction with manufacturing and use techniques currently used in the art, and only so much of the commonly practiced process steps are included as are necessary for an understanding of the present invention.

### DETAILED DESCRIPTION

As used in the specification and claims, the term “lamination seam” is defined as the junction formed when two of the cured pressure sensitive adhesives are laminated together.

As described above, the present invention relates to a microsphere containing electron beam cured rubber based pressure sensitive adhesive tape. The tape comprises a core layer and at least one skin layer. The tape generally has a thickness from about 5 to about 100 mils, or from about 10 to about 80 mils, or from about 15 to about 70 mils.

Core Layer

The core layer may be a monolayer or a multilayer. The core includes an electron beam cured rubber based pressure sensitive adhesive and microspheres. The core may include a lamination seam, a second core layer or a non-woven support layer. In one embodiment, the thickness of the core is in the range of from about 5 mils to about 100 mils, or from about 10 to about 80 mils, or from about 15 mils to about 70 mils.

The pressure sensitive adhesive core includes at least one electron beam cured rubber-based adhesive, and at least one microsphere. In one embodiment, the EB-cured, rubber-based pressure sensitive adhesive constitutes from about 35% to about 70% by volume, or from about 40% to about 65% by volume, or from about 50% to about 60% by volume, of the core layer, the balance being made up of fillers including the microspheres. In this and throughout the specification and claims, the limits of the ranges and ratios may be combined. Thus, for example, in the foregoing disclosure, a range from about 30% to about 60% by volume, although not specifically disclosed, would be contemplated within the scope of the foregoing disclosure.

Rubber-based PSA polymer matrices useful in the present invention may be formulated as solvent, hot melt, or emulsion based adhesives. In one embodiment, the adhesive is a hot melt, and in another embodiment, a solvent based adhesive. In one embodiment, the PSA matrices employed are based on di-block and tri-block polymers and mixtures thereof. Other resin modified elastomers could be used. In one embodiment, the EB-curable rubber-based core polymer has a net effective glass transition temperature (Tg) of from about 15° C. to about 70° C. below the use temperature. In another embodiment, the rubber-based core polymer has a net effective glass transition temperature (Tg) of from about 30° C. to about 60° C. below the use temperature. Rubber-based materials suitable for use as the electron-beam cured rubber-based PSA in the present invention are described, for example, in U.S. Pat. No. 3,239,478 to Harlan, U.S. Pat. No. 4,152,231 to St. Clair, et al., U.S. Pat. No. 3,676,202 to Korpman, U.S. Pat. No. 3,783,072 to Korpman, U.S. Pat. No. 3,932,328 to Korpman and U.S. Pat. No. 4,028,292 to Korpman; U.S. Pat. No. 4,820,746 to Rice et al. and U.S. Pat. No. 5,856,387, to Sasaki et al., all of which are incorporated herein by reference for their teachings relating to rubber-based PSA materials.

In one embodiment, the EB-curable rubber-based core polymers are block copolymers having or containing the tetrablock structure A-B-A-D, the triblock structure A-B-A and, optionally, the diblock structure A-B in lesser amounts as a minor component. In such block structures, A represents a block that is non-rubbery or glassy or crystalline at service temperature, e.g. in the range from about −20° C. to about 50° C. B and D, which may be the same, each represent a block that is rubbery or elastomeric at use temperature. At elevated temperatures, the A, B and D blocks are sufficiently fluid to enable coextrusion of the EB-curable rubber-based polymers.

In one embodiment, the EB-curable rubber-based pressure-sensitive adhesives useful in the present invention are one or more of styrene-butadiene-styrene, styrene-isoprene-styrene, styrene-butadiene and styrene-isoprene block copolymers, such as the KRATON® resins manufactured and sold by Shell Chemical Company.

Block copolymers that may be employed include thermoplastic block copolymers having linear, radial or star configurations and having the A blocks and B blocks formed into what are generally termed as ABA block copolymers. In one embodiment, the A block is a monoalkenyl arene, mainly polystyrene, having a molecular weight between about 4,000 and about 50,000, and in one embodiment between about 7,000 and about 30,000. Other suitable A blocks may be formed from alpha-methyl styrene, t-butyl styrene and other ring alkylated styrenes, as well as mixtures thereof. The A block content is from about 10% to about 50%, and in one embodiment between about 10% and about 30%. B is an elastomeric conjugated diene such as butadiene or isoprene having an average molecular weight of from about 5,000 to about 500,000, and in one embodiment from about 50,000 to 200,000. In one embodiment, ABA triblock and AB diblock copolymers comprise the majority of the block copolymer elastomer of the adhesive, the percent diblock being less than about 95% of the block copolymer, and in one embodiment less than about 85%, and in one embodiment less than about 75%. Other conventional diene elastomers may be used to a minor extent, but not so as to significantly affect the adhesion properties.

In one embodiment, the core is formed of selected thermoplastic elastomers. The thermoplastic elastomers of interest herein include any block copolymer having or containing the triblock structure A-B-A where A represents a block that is non-rubbery or glassy or crystalline at use or room temperature but fluid at higher temperatures, and B represents a block that is rubbery or elastomeric at service or room temperature. In addition to the A-B-A triblock structure, other possible structures include radial structures (A-B)ₓ A, where x is greater than 1, diblock structures A-B and combinations of these structures. The elastomer may comprise from about 60 to 95% rubbery segments by weight and from about 5 to about 40% non-rubbery segments by weight.

In one embodiment, the core comprises a thermoplastic elastomer such as SBS, SIS, SI, S(IS)ₓ and SEBS block copolymers and mixtures thereof sold by the Shell Chemical Company under the designations KRATON® D1102, D1107, D1111, D1112, D1117, D1125 and D4141 and KRATON® G1650. These elastomers have hardness, Shore A values ranging from 32 to 75 and styrene/rubber ratios ranging from 14/86 to 29/71.

Specific examples of ABA-type copolymers of styrene and isoprene are KRATON® 1107 and KRATON® 1117 from Shell Chemical Company. ABA-type copolymers of styrene-butadiene are available from Shell Chemical Company under the designations KRATON® 1101 and KRATON® 1102. Other commercially available copolymer adhesives include: random copolymer of ethylene and vinyl acetate having a melt-flow index of 2500 and a vinyl acetate content of 14% by weight (ESCORENE® MVO-2514) available from Exxon Chemical; styrene butadiene block synthetic rubber having a styrene content of 30% by weight (FINAPRENE® 411) available from Fina Chemical Company; random copolymer of ethylene and vinyl acetate having a melt-flow index of 148 and a vinyl acetate content of 18.5% by weight (ELVAX® 420) available from DuPont; and random copolymer of ethylene and vinyl acetate having a melt-flow index of 57 and a vinyl acetate content of 40% by weight of an ELVAX® 40W.

Tackifier additives useful in the present invention include rosin or rosin derivatives, polyterpenes, hydrocarbon resins and the like. Useful commercially available tackifiers include rosin esters such as those available under the trade name FORAL 85 from Hercules, Inc., terpene resins such as that available under the trade name PICCOLYTE A-115 from Hercules, Inc. and ZONAREZ B-100 from Arizona Chemical Co. Other commercially available tackifiers include REGALITE R91, REGALITE R101, REGALITE RS100, and REGALITE RS 260, REGALREZ 1018, REGALREZ 3102, REGALREZ 6108, and REGALREZ 5095, ZONATAC LITE series such as ZONATAC 105 Lite, ESCOREZ 5300 series, FORAL AX and FORAL 105, and Herculin D.

Crosslinking agents may be added to the adhesive composition of the present invention. In one embodiment, the crosslinking agent comprises a polythiol. Useful polythiols include pentaerythritoltetrathioglycolate (PETTG), dipentaerythritoltetra(3-mercaptopropionate), pentaerythritoltetra(3-mercaptopropionate) (PETMP), trimethylolethanetrimercaptopropionate (TMETMP), trimethylolpropanetrithioglycolate (TMPTG), glycoldimercaptoacetate; 2,2,dimercaptodiethylether, polyethyleneglycoldimercaptoacetate, polyethyleneglycol(3-mercaptopropionate, trimethyloltri(3-mercaptopropionate), trimethylolpropanetri(3-mercaptopropionate) (TMPTMP) and the like. Trimethylolpropanetri(3-mercaptopropionate) is particularly useful. Polythiol concentrated can range from up to about 10% by weight of more of the rubber, or from about 0.3 to about 3% by weight based on the total weight of the rubber, or 0.5 to about 2% by weight.

In one embodiment, in the electron beam (EB) employed as the energy source for curing the rubber-based PSA, the energy level of the EB may range from about 1 to about 100 kiloGray (kGy), and in one embodiment, from about 10 to about 50 kGy. Alternative energy sources, such as ultraviolet radiation may be used in conjunction with the EB radiation. UV irradiation may require use of a photoinitiator.

As described above, the core layer also includes at least one microsphere. In general, the microspheres may be solid, hollow or porous and rigid or non-rigid. The microspheres may be made of any suitable material including glass, ceramic, polymers and carbon materials. The microspheres of the core layer are generally in the size range of from about 10 microns to about 300 microns. In one embodiment, the microspheres are present in an amount from about 30% to about 65%, or from about 35% to about 60%, or from about 40% to about 60% by volume of the core layer.

The polymeric microspheres may be made of any suitable polymeric material. Mixtures of such low density microspheres may be used. The polymeric microspheres may be tacky or nontacky. In one embodiment, the polymeric material of the microspheres may be selected to cross-link with the PSA polymer matrix during EB-curing.

Polymeric microspheres may be made of rigid materials or elastomeric materials. Suitable rigid polymeric materials include thermosetting polymers, e.g., phenolic polymers, or thermoplastic polymers, e.g., polyvinylidene chloride acrylonitrile copolymers (PVDC copolymers). In one embodiment, the thermoplastic polymer microspheres cross-link and graft to the polymer matrix when EB radiation is used to cure the polymer matrix. By cross-linking the microspheres and grafting to the polymer matrix, properties such as tensile strength may be improved.

Elastomeric microspheres are described in U.S. Pat. No. 3,691,140 to Silver, U.S. Pat. Nos. 3,857,731 and 4,166,152 to Baker et al., U.S. Pat. No. 4,495,318 to Howard, and U.S. Pat. No. 4,810,763 to Mallya, et al. These patents are incorporated herein by reference for their teachings relating to polymeric microspheres. Infusible low density microspheres are disclosed in U.S. Pat. Nos. 4,735,837, 4,049,483, 4,645,783, 4,624,893, 4,636,432, 4,598,112, and Japanese Patent No. 61258854. These references are incorporated herein by reference for their disclosures of microspheres. Incorporation of elastomeric microspheres in the core layer may improve the low temperature performance of the foam tapes of the present invention, particularly in cold slam tests, e.g., General Motors Testing GM 9023P, at temperatures of, for example, 20° C. and 30° C.

The non-rigid polymeric microspheres may be expandable microspheres, such as the EXPANCEL® expandable microspheres, manufactured by Casco Products, a division of AKZO NOBEL, and available from Expancel Inc., Duluth, Ga., USA. EXPANCEL® microspheres are small spherical plastic particles. Another example of suitable commercially available expandable polymeric microspheres include those available from Pierce Stevens (Buffalo, N.Y.) under the designations “F30D,” “F80SD,” and “F100D.” The expandable microspheres generally consist of a polymer shell encapsulating a gas or vaporizable liquid. When the gas inside the shell is heated, or the liquid vaporized, it increases its pressure and the thermoplastic shell softens, resulting in a dramatic increase in the volume of the microspheres. When fully expanded, the volume of the microspheres may increase more than 40 times their original volume. In other embodiments, other known non-rigid, polymeric microspheres may be used in the core. The density of such polymeric microspheres may range from about 30 to about 70 kg/m³ (about 0.03 to about 0.07 g/cm³) for expanded microspheres. Prior to expansion, the density of such polymeric microspheres may range from about 1000 to about 1300 kg/m³ (about 1 to about 1.3 g/cm³). The expansion temperature of such polymeric microspheres may range from about 60° C. to about 200° C., and in one embodiment from about 80° C. to about 190° C.

In one embodiment, the microspheres are hollow. Such microspheres are generally available in a wide range of densities and crush strengths. In some embodiments, ceramic hollow microspheres are useful because they exhibit high crush strength and tend to be less expensive than glass, polymeric or carbon hollow microspheres.

An uncoated hollow phenolic microsphere product is commercially available under the trade name PHENOSET from Eastech Chemical of Philadelphia, Pa. PHENOSET BJO-0840 microspheres are characterized by a density of 0.10 to 0.15 grams/cm³ and a particle size distribution curve having a mode at about 70 microns. PHENOSET BJP-0930 microspheres are characterized by a maximum density of 0.104 grams/cm³ and a particle size distribution curve having a mode at about 90 microns.

In one embodiment, the microspheres are fully expanded. In one embodiment, the microspheres are fully expanded prior to extrusion or coating of the PSA tape core in which the microspheres are included. In one embodiment, the microspheres are expanded by a heating step in which the EB-curable PSA components are mixed. In one embodiment, the microspheres are expanded by a heating step in which the EB-curable PSA components are mixed while dissolved in a solvent. Useful solvents are discussed below. In one embodiment, the solvent comprises from about 20% to about 90% of a solution in which the PSA components are dissolved. In another embodiment, the solvent comprises from greater than 20% up to about 80% of the solution.

In one embodiment, the microspheres are rigid, and may be composed of, e.g., glass or a phenolic or styrenic polymer. In such embodiments, the microspheres are expanded prior to addition to the rubber-based polymer composition used for the core.

In one embodiment, the core comprises rigid microspheres made of, for example, glass or ceramic having a density of from about 0.2 to about 1.0 g/cm³, and the loading of microspheres does not exceed about 45%, because core layers with higher loadings tend to exhibit reduced elongation. In an embodiment in which rigid polymeric microspheres having a density less than about 0.2 g/cm³, e.g., hollow phenolic microspheres, are used, the loading may be as high as about 60% by volume. If non-rigid polymeric microspheres are used, loadings as high as about 60% by volume may be used.

In one embodiment, the core includes a filler such as fumed silica. Fillers such as fumed silica lower the elongation and increase the tensile strength of the core. Accordingly, the amount of fumed silica is selected to provide the best balance of high elongation and high tensile strength. In one embodiment, the filler is present in an amount of up to about 10% by weight of the core. In some embodiments, loadings greater than about 10% may result in a core that is too stiff and insufficiently conformable for some applications. In one embodiment, the volume loadings range from about 3% to about 5% by weight, this range imparts a good combination of tensile strength and elongation.

In some embodiments, alternative fillers, such as small, rigid high density solid microspheres having a density greater than about 1 g/cm³ and a size or average diameter of less than about 10 microns and in one embodiment from about 0.1 to about 5 microns, may be used as an alternative to or in combination with fillers such as fumed silica to lower the elongation and increase the tensile strength of the core layer. In one embodiment, the small, rigid, high density solid microspheres may be present in an amount of up to about 5% by weight. In one embodiment, the small, rigid, high density solid microspheres are present in an amount of from about 1% to about 2% by weight.

It is understood that the loadings of the various above-mentioned fillers are dependent upon the precise characteristics that are sought and on the amounts of the other fillers present in the core layer. For example, in one embodiment, a relatively high loading of solid fillers, e.g., fumed silica or small, rigid, high density microspheres may be used if the loading of low density microspheres is low. Similarly, lower loadings may be used if the amount of microspheres is high.

In other embodiments, many other fillers, e.g., calcium carbonate, china clay, etc., may be incorporated into the core layers as desired.

In one embodiment, the core layer is free of rigid microspheres.

Skin Layer

As described above, the core layer has at least one skin layer on its surface. The skin layer may be a monolayer or a multilayer. Typically, the skin layer is a single monolayer. In one embodiment, the thickness of the skin layer is in the range from about 10 to about 250 grams/square meter, which corresponds to about 10 microns to about 250 microns (0.25 mm) in thickness (assuming a PSA density of about 1 g/cm³). The skin layers are substantially free (e.g., less than 5%, or less that 1% by volume) or free of microspheres. In one embodiment, the skin layers are unfilled layers of an EB-cured rubber-based polymer. In one embodiment, the skin layers may be filled with pigment.

The electron-beam cured rubber-based polymers of the skin layers may be any of those disclosed above with respect to the core. The particular rubber-based polymer selected for use in the skin layer may be the same as or different from the rubber-based polymer used in the core.

Tape

The PSA tape of the present invention may be prepared by any suitable method. For example, in one embodiment, a mixture of the rubber-based polymer matrix, microspheres, any fillers and solvent may be coated onto a backing film to a desired thickness. The solvent is then removed by drying before curing. A skin layer may be coated onto the dried core layer. Conversely, a skin layer may be coated first to the backing film and then the core layer is coated onto the dried skin layer.

In another embodiment, The core and skin layer may be may be extruded as a sheet or the like, and this sheet then cured. A calendaring process may also be used in laminating together various embodiments of the extruded tapes.

In one embodiment, the core is made by first preparing an adhesive composition containing the polymer matrix, solvent for the polymer matrix and the desired fillers. The composition is introduced into an extruder and conveyed through the extruder by the rotating screws. While in the extruder, the solvent is removed by vacuum evaporation in one or more solvent removal units. An essentially solvent-free composition is then extruded from the extruder. As used herein, “solvent-free” means a composition having less than about 2% by volume solvent.

Exemplary solvents include ethyl acetate, isopropanol, ethanol, hexane, heptane and toluene. The purpose of the solvent is to reduce the viscosity of the composition so that it may be easily handled in bulk, e.g., readily poured from one container to another. In one embodiment, the amount of solvent is that sufficient to reduce the viscosity to less than about 100 pascal-seconds. For most compositions, an amount of solvent that provides a solids content of from about 40% to about 80% is sufficient for this purpose. In one embodiment, compositions having more than about 80% solids may have an undesirably high viscosity. In another embodiment, compositions having less than about 40% solids may contain excess solvent, i.e. more than enough solvent to reduce the viscosity to an easily workable level, and the excess solvent must be removed in the process. The particular viscosity desired will depend on the method by which the composition is introduced into the extruder, and the type of solvent removal system used. One solvent removal system is disclosed in U.S. Pat. No. 5,100,728, which is incorporated herein by reference for its teaching relating to solvent removal.

In another embodiment, the adhesive composition of the core and skin layers is manufactured without the addition of solvents. The core and skin layers are coextruded onto a carrier film or release liner.

In an embodiment in which the adhesive tape includes two skin layers, the skin layers need not be of the same composition. The use of different adhesive compositions may be advantageous since the skin layers generally will not be adhered to like materials in the applications for which the present invention is contemplated. However, it is often convenient to use the same adhesive for production purposes. Suitable EB-cured rubber-based pressure-sensitive adhesives are described above.

In one embodiment, the substrate or the object, or both, to which the EB-cured PSA tape is to be adhered comprises a surface of one or more of a thermoplastic, metal, glass, a thermoset resin or a paint. In one embodiment, the thermoplastic is a thermoplastic polyolefin (TPO). In one embodiment, the surface is unprimed. In one embodiment, the TPO is unprimed. In one embodiment, the substrate is a vehicle. In one embodiment, the vehicle is an automobile. In one embodiment, the object is a body-side molding for a vehicle.

The presently disclosed EB-cured PSA tapes are particularly useful for bonding parts, such as body-side moldings, emblems, pin-striping and other objects to outer surfaces of substrates such as automobiles, motorcycles, bicycles, watercraft such as ships, yachts, boats and personal watercraft, aircraft and other kinds of both land, sea and air vehicles. The presently disclosed EB-cured PSA tapes are particularly resistant to elements encountered in the use of such substrates, including petroleum-based materials like gasoline, lubricants, water-based materials such as detergents, windshield washer fluids, rain, salty water, and mixtures of the foregoing (e.g., “road grime”) as might be encountered by motor vehicles on a regular basis. In addition, the presently disclosed EB-cured PSA tapes are resistant to physical forces, having improved peel strengths and thereby avoiding removal by physical forces such as impacts, snags, vandalism or other forces which might otherwise cause the object to be removed from the substrate.

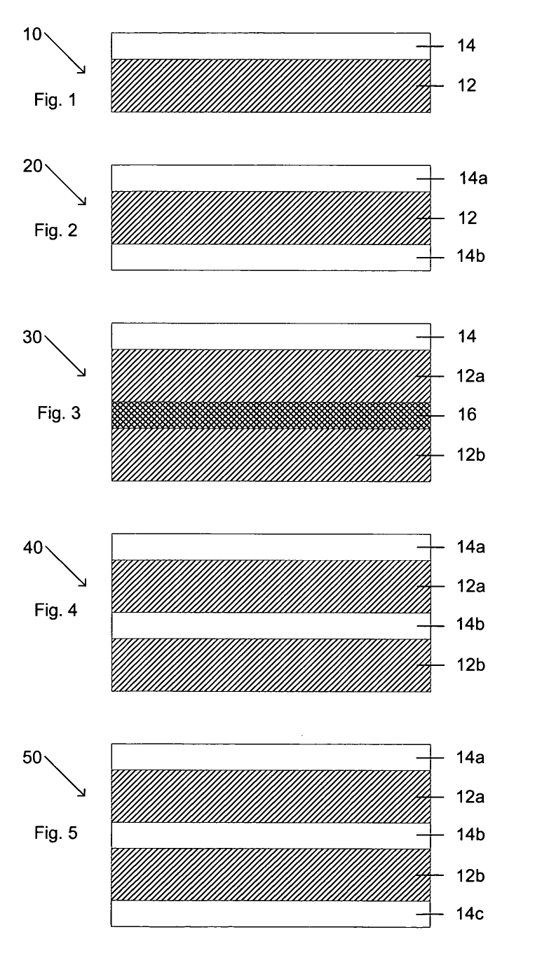

FIG. 1 is a schematic cross-sectional view of an adhesive tape 10 in accordance with one embodiment of the present invention. The tape 10 includes an EB-cured rubber-based PSA core 12, and an EB-cured rubber-based PSA skin layer 14. In accordance with the present invention, the core 12 includes microspheres, and the skin layer 14 is substantially free of microspheres.

FIG. 2 is a schematic cross-sectional view of an adhesive tape 20 in accordance with another embodiment of the present invention. The tape 20 includes an EB-cured rubber-based PSA core 12, and a pair of EB-cured rubber-based PSA skin layers 14a, 14b, adhered to the first and second major faces on the core 12. In accordance with the present invention, the core 12 includes microspheres, and the skin layers 14a and 14b are substantially free of microspheres.

FIG. 3 is a schematic cross-sectional view of an adhesive tape 30 in accordance with yet another embodiment of the present invention. The tape 30 includes a first EB-cured rubber-based PSA core 12a, an EB-cured rubber-based PSA skin layer 14, a second EB-cured rubber-based PSA core 12b, and a support layer 16 between the first core 12a and the second core 12b. In accordance with the present invention, both the first core 12a and second core 12b include microspheres, and the skin layer 14 is substantially free of microspheres. The support layer 16 may be, for example, a polymer sheet, woven or non-woven. Such a support layer 16 may have a thickness in the range from about 25 microns to about 500 microns (about 1 mil to about 20 mils), and in one embodiment from about 50 microns to about 250 microns, and in another embodiment from about 60 microns to about 100 microns, and in one embodiment, about 75 microns (about 3 mils). An example of a useful support layer is a 0.3 mil non-woven available commercially under the trade name Cerex.

FIG. 4 is a schematic cross-sectional view of an adhesive tape 40 in accordance with still another embodiment of the present invention. The tape 40 includes a first EB-cured rubber-based PSA core 12a, a pair of EB-cured rubber-based PSA skin layers 14a, 14b, adhered to the first and second major faces on the first core 12a, and a second EB-cured rubber-based PSA core 12b adhered to the opposite face of the skin layer 14b. In accordance with the present invention, both the first core 12a and the second core 12b include microspheres, and both the first skin layer 14a and the second skin layer 14b are substantially free of microspheres.

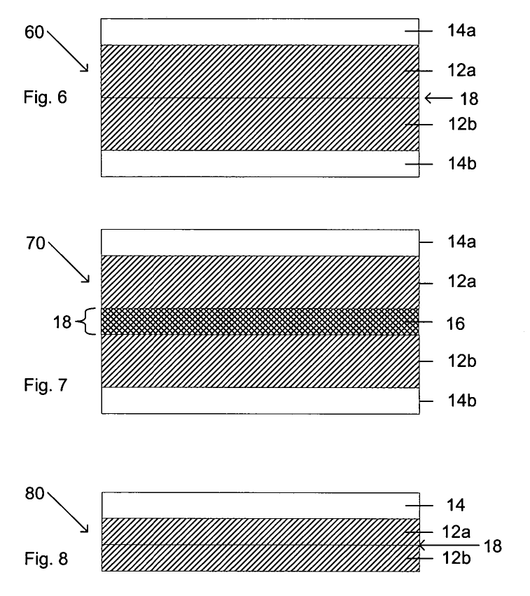

FIG. 5 is a schematic cross-sectional view of an adhesive tape 50 in accordance with yet another embodiment of the present invention. The tape 50 includes a first EB-cured rubber-based PSA core 12a, a pair of EB-cured rubber-based PSA skin layers 14a, 14b, adhered to the first and second major faces on the first core 12a, a second EB-cured rubber-based PSA core 12b adhered to the opposite face of the skin layer 14b, and a third skin layer 14c adhered to the second major face of the second core 12b. In accordance with the present invention, both the first core 12a and the second core 12b include microspheres, and each of the first skin layer 14a, the second skin layer 14b, and the third skin layer 14c are substantially free of microspheres.

FIG. 6 is a schematic cross-sectional view of an adhesive tape 60 in accordance with still another embodiment of the present invention. The tape 60 includes a first EB-cured rubber-based PSA core 12a, and a first EB-cured rubber-based PSA skin layer 14a adhered to the first major face on the first core 12a, and a second EB-cured rubber-based PSA core 12b, the first major face of which is adhered to the second major face of the first core 12a, and a second EB-cured rubber-based skin layer 14b adhered to the second major face of the second core 12b. A lamination seam 18 is defined at the interface between the first core 12a and the second core 12b. In accordance with the present invention, both the first core 12a and the second core 12b include microspheres, and both the first skin layer 14a and the second skin layer 14b are substantially free of microspheres.

FIG. 7 is a schematic cross-sectional view of an adhesive tape 70 in accordance with still another embodiment of the present invention. The tape 70 includes a first EB-cured rubber-based PSA core 12a, and a first EB-cured rubber-based PSA skin layer 14a adhered to the first major face on the first core 12a, and a second EB-cured rubber-based PSA core 12b, the first major face of which is adhered to the second major face of the first core 12a, a second EB-cured rubber-based skin layer 14b adhered to the second major face of the second core 12b, and a support layer 16 between the first core 12a and the second core 12b. The support layer 16 is substantially the same as that described above with respect to the support layer 16 shown in FIG. 3. In accordance with the present invention, both the first core 12a and the second core 12b include microspheres, and both the first skin layer 14a and the second skin layer 14b are substantially free of microspheres.

FIG. 8 is a schematic cross-sectional view of an adhesive tape 80 in accordance with an embodiment of the present invention similar to that of FIG. 1, except that it includes a lamination seam in the core. The tape 80 includes a first EB-cured rubber-based PSA core 12a, and an EB-cured rubber-based PSA skin layer 14 adhered to the first major face on the first core 12a, and a second EB-cured rubber-based PSA core 12b, the first major face of which is adhered to the second major face of the first core 12a. A lamination seam 18 is defined at the interface between the first core 12a and the second core 12b. In accordance with the present invention, both the first core 12a and the second core 12b include microspheres, and the skin layer 14 is substantially free of microspheres.

The following example relates to examples of the compositions and the procedures for making the electron beam cured pressure sensitive adhesive tapes.

### EXAMPLE 1

An EB-curable rubber-based PSA core is prepared by mixing as a solution in toluene at 50% by weight solids, a mixture of 95.8% by weight (dry weight) of a rubber-based adhesive solution, 0.9% by weight trimethylolpropane tris (3-mercaptopropionate) (TMPTMP), as a cross-linking additive and 3.9% by weight (32% by volume) hollow non-rigid polymeric microspheres. The mixture is stirred in a sigma bladder mixer at 190° C. for approximately one half hour. The adhesive solution contains about 19.3% by weight styrene-butadiene-styrene linear copolymer containing about 31% styrene, about 16.1% by weight styrene-butadiene copolymer, about 25.8% by weight alpha pinene tackifier, about 32.3% by weight rosin ester tackifier, and about 6.4% by weight of a compatible aromatic liquid resin. The solvent is stripped off by vacuum.

For the skin layers, the same EB-curable, rubber-based PSA is prepared as for the core layer, except that no microspheres are added to the solution. The solvent is stripped off by vacuum.

An adhesive tape is prepared by co-extruding a 50 micron skin layer (coat weight about 50 g/m²) and a 0.8 mm core onto a release liner. The adhesive tape is electron beam irradiated on both sides at 275 kv and 50 kGR open faced, as the tape emerges from the extrusion device to form a structure such as shown in FIG. 1. A second release liner is applied to the adhesive tape. (It is noted that in actual use, a release liner may or may not be applied at this point, depending on whether the adhesive tape is to be laminated to other tapes or other layers.)

### EXAMPLE 2

An EB-curable rubber-based PSA composition is prepared substantially as in Example 1, including 90.8% by weight (dry weight) of the adhesive used in Example I, 3.8% by weight hollow non-rigid polymeric microspheres, 1.8% by weight BJO 0930 hollow phenolic microspheres, available from Eastech Chemical, Inc., Philadelphia, Pa., and 3.6% by weight Cab-O-Sil® fumed silica from Cabot Corp., Boston, Mass. The solvent is stripped off by vacuum.

For the skin layers, the same EB-curable, rubber-based PSA is prepared as for the core layer, except that no microspheres are added to the solution. The solvent is stripped off by vacuum.

An adhesive tape is prepared by co-extruding a 50 micron skin layer (coat weight about 50 g/m²) and a 0.8 mm core onto a release liner. The adhesive tape is electron beam irradiated on both sides at 275 kv and 50 kGR, as the tape emerges from the extrusion device.

Peel adhesion is measured after laminating one side of the tape to 0.127 mm Mylar. The core by itself demonstrates a peel strength of 5300 N/m on a stainless steel substrate and 2960 N/m on a TPO substrate. The skin layer exhibits a peel strength of 9400 N/m on a stainless steel substrate and 3130 N/m on a TPO substrate.

It is expected that the above samples could be formulated with at least about 3% TMPTMP for electron beam curing to improve high temperature performance without adversely affecting the above demonstrated peel strength.

The adhesive tapes prepared in Examples 1 and 2 correspond to the tape shown in FIG. 1. The tape shown in FIG. 1 does not show the release liner(s).

### EXAMPLE 3

A double-sided adhesive tape, such as that shown in FIG. 2, is prepared by coextruding onto a release liner a core layer with two skin layers, one on each major face of the core layer, using the EB-curable, rubber-based PSA compositions prepared in EXAMPLE 2. The double-sided EB-curable, rubber-based PSA is electron beam irradiated on both sides at 275 kv and 50 kGR, as the tape emerges from the extrusion device. A second release liner is applied to the adhesive tape. The tape shown in FIG. 2 does not show the release liners.

### EXAMPLE 4

A laminated adhesive tape, such as that shown in FIG. 3, is prepared as follows. An EB-curable rubber-based PSA tape is prepared substantially as described in EXAMPLE 1, including extrusion and EB curing. The second major face of the core layer being left uncovered. A second core is prepared by preparing a core as described in EXAMPLE 1, extruding and EB curing the second core. The second major face of the second core is left uncovered. Next, a 3 mil non-woven PET support layer is provided. A laminated adhesive tape is prepared by applying the uncovered second major face of the first core to one side of the 3 mil non-woven PET support layer and applying the uncovered second major face of the second core to the other side of the support layer, thus forming a laminated adhesive tape as shown in FIG. 3. The tape shown in FIG. 3 does not show the release liners.

### EXAMPLE 5

An adhesive tape, such as that shown in FIG. 4, is prepared as follows. An EB-curable rubber-based PSA tape is prepared substantially as described in EXAMPLE 1, including extrusion and EB curing, the second major face of the core layer being left uncovered. A second EB-curable rubber-based PSA tape is prepared as described in EXAMPLE 1, including extrusion and EB curing, the skin layer being left uncovered. Next, the uncovered skin layer of the second tape is laminated to the uncovered core of the first tape, to form a structure such as that shown in FIG. 4. The tape shown in FIG. 4 does not show the release liners.

It is noted that the structure shown in FIG. 4 could be prepared by co-extrusion of all four layers. However, it is expected that a higher power EB cure would be needed to adequately cure the inner layers of such a coextrudate.

### EXAMPLE 6

A double-sided, laminated adhesive tape, such as that shown in FIG. 5, is prepared by coextruding a core layer with two skin layers, one on each major face of the core layer, using the EB-curable, rubber-based PSA compositions prepared in EXAMPLE 2. The double-sided EB-curable, rubber-based PSA is electron beam irradiated on both sides at 275 kv and 50 kGr, as the tape emerges from the extrusion device. One of the skin layers is left uncovered. A second adhesive tape is prepared substantially as described in EXAMPLE 1, with the core side left uncovered. Next, the uncovered skin layer side of the first adhesive tape is laminated to the uncovered core side of the second adhesive tape, to form a structure such as that shown in FIG. 5. The tape shown in FIG. 5 does not show the release liners.

It is noted that the structure shown in FIG. 5 could be prepared by co-extrusion of all four layers. However, it is expected that a higher power EB cure would be needed to adequately cure the inner layers of such a coextrudate.

### EXAMPLE 7

A double-sided, laminated adhesive tape, such as shown in FIG. 6, is prepared as follows. Two adhesive tapes are prepared substantially as in EXAMPLE 1, with the skin side adjacent to the release liner of each tape, the second major faces of the cores being left uncovered. Next, the uncovered second major faces of the cores are laminated together to form a structure such as that shown in FIG. 6. The tape shown in FIG. 6 does not show the release liners.

It is noted that the structure shown in FIG. 6 could be prepared by co-extrusion of all four layers. However, it is expected that a higher power EB cure would be needed to adequately cure the inner layers of such a coextrudate.

### EXAMPLE 8

A double-sided, laminated adhesive tape, such as shown in FIG. 7, is prepared as follows. Two adhesive tapes are prepared substantially as in EXAMPLE 1, with the skin side adjacent to the release liner for both tapes, the second major faces of the cores being left uncovered. Next, a 3 mil non-woven PET support layer is provided. A double-sided, laminated adhesive tape is prepared by applying the uncovered second major faces of the cores to each side of the 3 mil non-woven PET support layer, thus forming a laminated adhesive tape as shown in FIG. 7. The tape shown in FIG. 7 does not show the release liners.

### EXAMPLE 9

An EB-curable rubber-based PSA core is prepared by mixing as a solution in toluene at 50% by weight solids, a mixture of 95.8% by weight (dry weight) of a rubber-based adhesive solution, 0.9% by weight trimethylolpropane tris (3-mercaptopropionate) (TMPTMP), as a cross-linking additive and 3.9% by weight (32% by volume) hollow non-rigid polymeric microspheres. The ingredients are mixed in a sigma blade mixer for one half hour at 190° C. The adhesive solution contains about 19.3% by weight styrene-butadiene-styrene linear copolymer containing about 31% styrene, about 16.1% by weight styrene-butadiene copolymer, about 25.8% by weight alpha pinene tackifier, about 32.3% by weight rosin ester tackifier, and about 6.4% by weight of a compatible aromatic liquid resin. The solvent is stripped off by vacuum.

For the skin layers, the same EB-curable, rubber-based PSA is prepared as for the core layer, except that no microspheres are added to the solution. The solvent is stripped off by vacuum.

An adhesive tape is prepared by coating the skin layer onto a release liner at a coat weight about 50 g/m². The core is coated onto the skin layer at a thickness of about 0.8 mm. The adhesive tape is electron beam irradiated on both sides at 275 kv and 50 kGr, open faced, as the tape emerges from the extrusion device to form a structure such as shown in FIG. 1. A release liner is applied to the exposed side of the adhesive tape. (It is noted that in actual use, a release liner may or may not be applied at this point, depending on whether the adhesive tape is to be laminated to other tapes or other layers.)

### EXAMPLE 10

An EB-curable rubber-based PSA composition is prepared substantially as in Example 1 including 90.8% by weight (dry weight) of the adhesive used in Example 1, 3.8% by weight hollow non-rigid polymeric microspheres, 1.8% by weight BJO 0930 hollow phenolic microspheres, available from Eastech Chemical, Inc., Philadelphia, Pa., and 3.6% by weight Cab-O-Sil® fumed silica from Cabot Corp., Boston, Mass. The solvent is stripped off by vacuum.

For the skin layers, the same EB-curable, rubber-based PSA is prepared as for the core layer, except that no microspheres are added to the solution. The solvent is stripped off by vacuum.

An adhesive tape is prepared by coating a 50 micron skin layer (about 50 g/m²) onto a release liner. A 0.8 mm core is then coated onto the skin layer. A second skin layer is coated onto the core layer and adhesive tape is electron beam irradiated at 275 kv and 50 kGr. A release liner is applied to the exposed side of the adhesive tape.

It is expected that the above samples could be formulated with at least about 3% TMPTMP for electron beam curing to improve high temperature performance without adversely affecting the above demonstrated peel strength.

The adhesive tapes prepared in Examples 1 and 2 correspond to the tape shown in FIG. 1. The tape shown in FIG. 1 does not show the release liners.

### EXAMPLE 11

A laminated adhesive tape, such as that shown in FIG. 3, is prepared as follows. An EB-curable rubber-based PSA tape is prepared substantially as described in EXAMPLE 9, and including EB curing. A second core is prepared, as described in EXAMPLE 1, by coating it onto a release liner. Next, a 3 mil non-woven PET support layer is provided. A laminated adhesive tape is prepared by applying the first core of the first tape to one side of the 3 mil non-woven PET support layer and applying the second core to the second tape to the other side of support layer, thus forming a laminated adhesive tape as shown in FIG. 3. The tape shown in FIG. 3 does not show the release liners.

### EXAMPLE 12

An adhesive tape, such as that shown in FIG. 4, is prepared as follows. An EB-curable rubber-based PSA tape is prepared substantially as described in EXAMPLE 9, including EB curing. A second EB-curable rubber-based PSA tape is prepared as described in EXAMPLE 9, including EB curing. The release liner is removed form the skin layer and the exposed skin layer is laminated to the core layer of the first tape. A release liner may be applied to the core layer of the second tape to make handling easier. The tape shown in FIG. 4 does not show the release liners.

### EXAMPLE 13

A double-sided, laminated adhesive tape, such as shown in FIG. 6, is prepared as follows. Two adhesive tapes are prepared substantially as in EXAMPLE 9, and the exposed core layers of the two tapes are laminated together. The tape shown in FIG. 6 does not show the release liners.

### EXAMPLE 14

A laminated adhesive tape as shown in FIG. 8 is prepared by laminating a tape prepared substantially as described in Example 9 with a tape prepared by coating a core layer onto a release liner. The exposed core layers of the tapes are laminated together.

It is noted that the structure shown in FIG. 7 could be prepared by co-extrusion of all four layers. However, it is expected that a higher power EB cure would be needed to adequately cure the inner layers of such a coextrudate.

### EXAMPLE 15

An EB-curable rubber-based PSA core is prepared by mixing together 38.8% by weight of SBS block copolymer KRAYTON® D1102, 9.7% by weight SIS block copolymer KRAYTON® D1107, 38.8% by weight rosin ester resin FORAL 85, 4.8% by weight PICCOLYTE A-115, 4.8% by weight HERCULIN D tackifier, 1% by weight carbon black and 1.9% by weight TMPTMP as a crosslinking agent. To the rubber based PSA 18% by weight (45% by volume) PHENOSET BJO-0840 microspheres is added For the skin layer, the same EB-curable rubber based PSA is prepared as for the core layer, except that no microspheres are added to the composition.

An adhesive tape is prepared by co-extruding onto a release liner a 50 micron skin layer and a 0.8 mm core layer. The adhesive tape is electron beam irradiated on both sides at 275 kv and 50 kGr, open faced, as the tape emerges from the extrusion device to form the structure illustrated in FIG. 1. A second release liner is applied to the adhesive tape.

The core and skin layers described in Example 15 are used to make a double-sided adhesive tape, as illustrated in FIG. 2. Similarly, the adhesive articles of FIGS. 3-8 can be manufactured with the core and skin layer compositions described in Example 15.

While the invention has been explained in relation to its preferred embodiments, it is to be understood that various modifications thereof will become apparent to those skilled in the art upon reading the specification. Therefore, it is to be understood that the invention disclosed herein is intended to cover such modifications as fall within the scope of the appended claims.

What is claimed is:

1. A pressure-sensitive adhesive tape, comprising:
an electron beam-cured rubber-based pressure-sensitive adhesive core comprising non-rigid polymeric microspheres and having first and second major faces; and
an electron beam-cured rubber-based pressure-sensitive adhesive skin layer adhered to the first major face,
wherein the electron beam-cured rubber-based pressure-sensitive adhesive skin layer is substantially free of microspheres.

2. The adhesive tape of claim 1, further comprising a second electron beam-cured rubber-based pressure-sensitive adhesive skin layer having a first major face and a second major face, wherein the first major face of the second electron beam-cured rubber-based pressure-sensitive adhesive skin layer is adhered to the second major face of the electron beam-cured rubber-based pressure-sensitive adhesive core.

3. The adhesive tape of claim 1, wherein the microspheres are fully expanded.

4. The adhesive tape of claim 3, wherein the microspheres are present in an amount from about 30% to about 60% by volume of the pressure-sensitive adhesive core.

5. The adhesive tape of claim 1, wherein the electron beam-cured rubber-based pressure-sensitive adhesive has improved adhesion to thermoplastic polyolefin surfaces.

6. The adhesive tape of claim 5, wherein the thermoplastic polyolefin is unprimed.

7. The adhesive tape of claim 2, further comprising a second electron beam-cured rubber-based pressure-sensitive adhesive core comprising non-rigid polymeric microspheres adhered to the second major face of the second electron beam-cured rubber-based pressure-sensitive adhesive skin layer.

8. The adhesive tape of claim 7, further comprising a third electron beam-cured rubber-based pressure-sensitive adhesive skin layer adhered to the second core.

9. The adhesive tape of claim 2, further comprising a non-woven polymeric support layer between the first major face of the second electron beam-cured rubber-based pressure-sensitive adhesive skin layer and the second major face of the electron beam-cured foamed rubber-based pressure-sensitive adhesive core.

10. The adhesive tape of claim 1 having a first and second outer surface, further comprising an object attached to the first outer surface of the adhesive tape.

11. The adhesive tape of claim 10, wherein the second outer surface of the adhesive tape is adhered to a substrate.

12. The adhesive tape of claim 1, wherein the electron beam-cured rubber-based pressure-sensitive adhesive core comprises a lamination seam.

13. A pressure-sensitive adhesive tape as in claim 1, further comprising:
a second electron beam-cured rubber-based pressure-sensitive adhesive core comprising non-rigid polymeric microspheres and having first and second major faces;
a second electron beam-cured rubber-based pressure-sensitive adhesive skin layer adhered to the first major face of the second electron beam-cured rubber-based pressure-sensitive adhesive core,
wherein the second electron beam-cured rubber-based pressure-sensitive adhesive skin layer is substantially free of microspheres and the second major face of the first core is adhered to the second major face of the second core, thus forming a lamination seam.

14. The pressure-sensitive adhesive tape of claim 13, wherein one of the first and second electron beam-cured rubber-based pressure-sensitive adhesive skin layers is adhered to an object.

15. The pressure-sensitive adhesive tape of claim 13, wherein one of the first and second electron beam-cured rubber-based pressure-sensitive adhesive skin layers is adhered to a substrate and another of the first and second electron beam-cured rubber-based pressure-sensitive adhesive skin layers is adhered to an object to be mounted on the substrate.

16. The pressure-sensitive adhesive tape of claim 15, wherein the substrate to which the tape is adhered comprises a surface of one or more of a thermoplastic, metal, glass, a thermoset or a paint.

17. The pressure-sensitive adhesive tape of claim 15, wherein the substrate is a vehicle.

18. The pressure-sensitive adhesive tape of claim 15, wherein the object is a body-side molding for a vehicle.

19. The pressure-sensitive adhesive tape of claim 13, further comprising a non-woven polymeric support layer between the second major face of the second electron beam-cured rubber-based pressure-sensitive adhesive skin layer and the second major face of the electron beam-cured foamed rubber-based pressure-sensitive adhesive core.

20. A double-sided adhesive tape, comprising:
a first electron beam-curable rubber-based pressure-sensitive adhesive core comprising microspheres and having first and second major faces;
a first electron beam-curable rubber-based pressure-sensitive adhesive skin layer adhered to the first major face of the first electron beam-curable rubber-based pressure-sensitive adhesive core;
a second electron beam-curable rubber-based pressure-sensitive adhesive core comprising microspheres and having first and second major faces, wherein the first major face of the second electron beam-curable rubber-based pressure-sensitive adhesive core is adhered to the second major face of the first electron beam-curable rubber-based pressure-sensitive adhesive core,
wherein a lamination seam is formed between the first electron beam-curable rubber-based pressure-sensitive adhesive core and the second electron beam-curable rubber-based pressure-sensitive adhesive core;
a second electron beam-curable rubber-based pressure-sensitive adhesive skin layer adhered to the first major face of the second electron beam-curable rubber-based pressure-sensitive adhesive core, wherein both the first and the second electron beam-curable rubber-based pressure-sensitive adhesive skin layers are substantially free of microspheres.

21. A double-sided adhesive tape, comprising:
a first electron beam-curable rubber-based pressure-sensitive adhesive core comprising microspheres and having first and second major faces;
an electron beam-curable rubber-based pressure-sensitive adhesive skin layer adhered to the first major face of the first electron beam-curable rubber-based pressure-sensitive adhesive core, wherein the electron beam-curable rubber-based pressure-sensitive adhesive skin layer is substantially free of microspheres;
a second electron beam-curable rubber-based pressure-sensitive adhesive core comprising microspheres and having first and second major faces, wherein the first major face of the second electron beam-curable rubber-based pressure-sensitive adhesive core is adhered to the second major face of the first electron beam-curable rubber-based pressure-sensitive adhesive core,
wherein a lamination seam is formed between the first electron beam-curable rubber-based pressure-sensitive adhesive core and the second electron beam-curable rubber-based pressure-sensitive adhesive core.

22. A method of making a pressure-sensitive adhesive tape, comprising:
providing an electron beam-curable rubber-based pressure-sensitive adhesive core comprising expanded polymeric microspheres and having first and second major faces;
applying an electron beam-curable rubber-based pressure-sensitive adhesive skin layer to the first major face;
curing the electron beam-curable rubber-based pressure-sensitive adhesive core and the electron beam-curable rubber-based pressure-sensitive adhesive skin layer by applying an electron beam to the core and the skin layer, wherein the electron beam-curable rubber-based pressure-sensitive adhesive skin layer is substantially free of microspheres.

23. The method of claim 22, further comprising applying a second electron beam-curable rubber-based pressure-sensitive adhesive skin layer to the second major face and curing the second electron beam-curable rubber-based pressure-sensitive adhesive skin layer, wherein the second electron beam-curable rubber-based pressure-sensitive adhesive skin layer is substantially free of microspheres.

24. The method of claim 22, wherein the expanded polymeric microspheres are non-rigid.

25. A method of mounting an object on a substrate, comprising:
providing an object and a substrate to which the object is to be adhered;
providing a first electron beam-curable rubber-based pressure-sensitive adhesive core comprising expanded polymeric microspheres and having first and second major faces;
applying a first electron beam-curable rubber-based pressure-sensitive adhesive skin layer to the first major face;
curing the first electron beam-curable rubber-based pressure-sensitive adhesive core and the first electron beam-curable rubber-based pressure-sensitive adhesive skin layer by applying an electron beam to the core and the skin layer to form a pressure-sensitive adhesive tape, wherein the first electron beam-curable rubber-based pressure-sensitive adhesive skin layer is substantially free of microspheres;
adhering the object to one side of the pressure-sensitive adhesive tape; and
adhering the other side of the pressure-sensitive adhesive tape to the substrate.

26. The method of claim 25, further comprising applying a second electron beam-curable rubber-based pressure-sensitive adhesive skin layer to the second major face and curing the second electron beam-curable rubber-based pressure-sensitive adhesive skin layer, wherein the second electron beam-curable rubber-based pressure-sensitive adhesive skin layer is substantially free of microspheres.

27. The method of claim 25, further comprising providing a second electron beam-curable rubber-based pressure-sensitive adhesive core comprising expanded polymeric microspheres and having first and second major faces;
applying a second electron beam-curable rubber-based pressure-sensitive adhesive skin layer to the first major face of the second electron beam-curable rubber-based pressure-sensitive adhesive core;
curing both the second electron beam-curable rubber-based pressure-sensitive adhesive core and the second electron beam-curable rubber-based pressure-sensitive adhesive skin layer by applying an electron beam to the second core and the second skin layer; and
applying the second major face of the second electron beam-curable rubber-based pressure-sensitive adhesive core to the second major face of the first electron beam-curable rubber-based pressure-sensitive adhesive core, thereby forming a composite pressure-sensitive adhesive tape having a lamination seam between the respective second major faces.

28. The method of claim 25, wherein the substrate to which the pressure-sensitive adhesive tape is adhered comprises a surface of one or more of a thermoplastic, metal, glass, a thermoset or a paint.

29. The method of claim 28, wherein the thermoplastic is thermoplastic polyolefin.

30. The method of claim 28, wherein the surface is unprimed.

31. The method of claim 25, wherein the substrate is a vehicle.

32. The method of claim 25, wherein the object is a body-side molding for a vehicle.

33. A method of mounting an object on a substrate, comprising:
providing an object;
providing a substrate;
providing a first electron beam-curable rubber-based pressure-sensitive adhesive core comprising microspheres and having first and second major faces;
applying a first electron beam-curable rubber-based pressure-sensitive adhesive skin layer to the first major face;
curing the first electron beam-curable rubber-based pressure-sensitive adhesive core and the first electron beam-curable rubber-based pressure-sensitive adhesive skin layer by applying an electron beam to the core and the skin layer, wherein the first electron beam-curable rubber-based pressure-sensitive adhesive skin layer is substantially free of microspheres;
providing a second electron beam-curable rubber-based pressure-sensitive adhesive core comprising microspheres and having first and second major faces;
applying a second electron beam-curable rubber-based pressure-sensitive adhesive skin layer to the first major face of the second electron beam-curable rubber-based pressure-sensitive adhesive core, wherein the second electron beam-curable rubber-based pressure-sensitive adhesive skin layer is substantially free of microspheres;
curing both the second electron beam-curable rubber-based pressure-sensitive adhesive core and the second electron beam-curable rubber-based pressure-sensitive adhesive skin layer by applying an electron beam to the second core and the second skin layer; and
applying the second major face of the second electron beam-curable rubber-based pressure-sensitive adhesive core to the second major face of the first electron beam-curable rubber-based pressure-sensitive adhesive core, the electron beam forming a pressure-sensitive adhesive tape having a lamination seam between the respective second major faces;
adhering the object to one side of the pressure-sensitive adhesive tape; and
adhering the other side of the pressure-sensitive adhesive tape to the substrate.
